(19) United States
(12) Patent Application Publication
(10) Pub. No.: US 2013/0169513 A1
(43) Pub. Date: Jul. 4, 2013

(54) WEARABLE COMPUTING DEVICE

(71) Applicants: Mitchell Joseph Heinrich, San Francisco, CA (US); Maj Isabelle Olsson, San Francisco, CA (US); John Lapetina, San Francisco, CA (US); Joseph John Hebenstreit, San Francisco, CA (US); Jianchun Dong, Palo Alto, CA (US); Harvey Ho, Mountain View, CA (US)

(72) Inventors: Mitchell Joseph Heinrich, San Francisco, CA (US); Maj Isabelle Olsson, San Francisco, CA (US); John Lapetina, San Francisco, CA (US); Joseph John Hebenstreit, San Francisco, CA (US); Jianchun Dong, Palo Alto, CA (US); Harvey Ho, Mountain View, CA (US)

(73) Assignee: GOOGLE INC., Mountain View, CA (US)

(21) Appl. No.: 13/343,313

(22) Filed: Jan. 4, 2012

(51) Int. Cl. G09G 5/00; H04R 1/00

(52) U.S. Cl. 345/8; 381/151

(57) ABSTRACT

A wearable computing device includes a bone conduction transducer, an extension arm, a light pass hole, and a flexible touch pad input circuit. When a user wears the device, the transducer contacts the user's head. A display is attached to a free end of an extension arm. The extension arm is pivotable such that a distance between the display and the user's eye is adjustable to provide the display at an optimum position. The light pass hole may include a light emitting diode and a flash. The touch pad input circuit may be adhered to at least one side arm such that parting lines are not provided between edges of the circuit and the side arm.

### BACKGROUND

Personal video or image displays are devices that are used to display an image received from a source for viewing by a single user. Such devices can be in the form of head-mounted displays that are worn on the head of a user and include one or more image sources over or in front of the user's eyes. Head-mounted displays can include an image source positioned adjacent and associated with each eye of the user or wearer and can be configured to present the same image, viewable as a single two-dimensional image. Alternatively, some such devices can be configured to present different stereoscopic images that are interpreted by the viewer as a single three-dimensional image. Regardless of the type of image presented to the user, such devices are usually blacked-out. That is, they almost entirely obstruct the wearer's vision outside of the screen or other image source included therein so that the user can see nothing but the image presented by the device's display system.

Other personal image displays can be what is referred to as heads-up displays, wherein the image is displayed on, in, or through a transparent display that superimposes the displayed image over a view of the surrounding environment. These devices allow the user to view the image presented by the display simultaneously with their surroundings. Such devices, however, can have many limitations, including in their fit and comfort to their wearers as well as limited functionality.

Both head-mounted and heads-up displays can be connected to a video source that receives a video signal that the device can read and convert into the image that they present to the user. The video source can be received from a portable device such as a video player, a portable media player or computers. Some such display devices are also configured to receive sound signals, which are delivered to the user typically through incorporated headphones. The functionality of these types of displays is, however, typically limited to passive actions wherein the display simply receives information from an external source and presents it to the wearer in limited forms.

### SUMMARY

Aspects of the present disclosure relate generally to a wearable computing device having a bone conduction transducer, an extension arm projecting from a side arm, a light pass hole, and a flexible touch pad input circuit. When a user wears the device, the transducer contacts the user's head at a position proximate the user's skull. A display attached to a free end of the extension arm is provided in the user's line of vision when the user wears the device. The extension arm is pivotable such that a distance of the display relative to the user is adjustable. Accordingly, the user may position the display at an optimum location in his line of vision. The light pass hole may include both a light emitting diode and a flash that may be used in conjunction with a camera. The flexible touch pad input circuit may be adhered to at least one side arm of the device such that parting lines are not provided between edges of the circuit and the corresponding side arm.

In one aspect, a computing device configured to be wearable on a user's head includes a center frame support, a first side arm extending from a first end of the center frame support, a second side arm extending from a second end of the center frame support, and a bone conduction transducer provided on one of the first and second side arms and configured to contact the user's head at a first location thereof. The first location is proximate the skull of the user's head.

In another aspect, computing device configured to be wearable on a user's head includes a center frame support, a first side arm extending from a first end of the center frame support, a second side arm extending from a second end of the center frame support, an extension arm projecting from one of the side arms in a direction proximate the center frame support, and a display attached to a free end of the extension arm. The display is configured to be provided proximate the user's line of vision for at least one eye.

### BRIEF DESCRIPTION OF THE DRAWINGS

FIG. 1 illustrates an example system for receiving, transmitting, and displaying data.

FIG. 2 illustrates an alternate view of the system of FIG. 1.

FIG. 3 illustrates an example schematic drawing of a computer network infrastructure.

FIGS. 4a and 4b illustrate a wearable computing device in accordance with an example embodiment.

FIG. 5 illustrates a partial, operational view of a wearable computing device in accordance with an example embodiment.

### DETAILED DESCRIPTION

The present disclosure is directed to a wearable computing device. The wearable device includes a bone conduction transducer, an extension arm, a light pass hole, and a flexible touch pad input circuit. When a user wears the device, the transducer contacts the user's head at a position proximate the user's skull. The extension arm projects from a side arm of the device and a display is attached to a free end of the extension arm. A distance of the display relative to the user is adjustable by pivoting the extension arm about an axis such that the user may view the display at an optimum position. The light pass hole may include both a light emitting diode and a flash that may be used in conjunction with a camera. The flexible touch pad input circuit may be adhered to at least one of the side arms such that parting lines are not provided between edges of the circuit and a surface of the corresponding side arm.

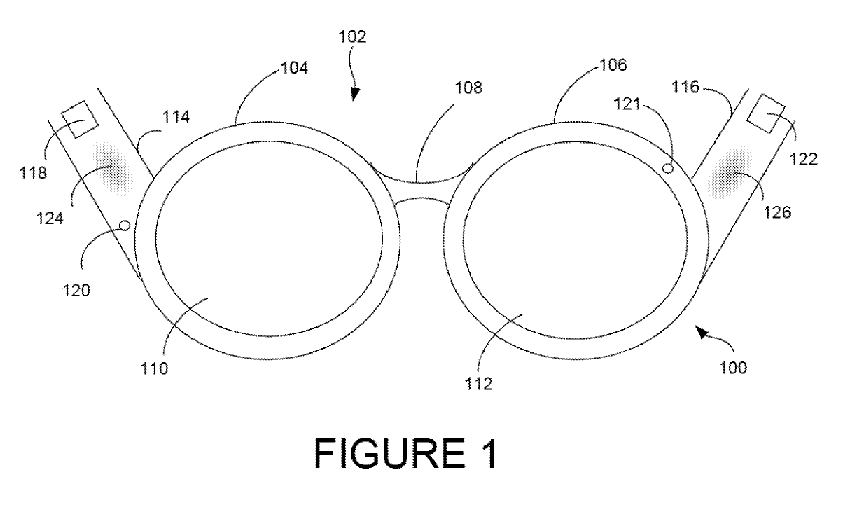

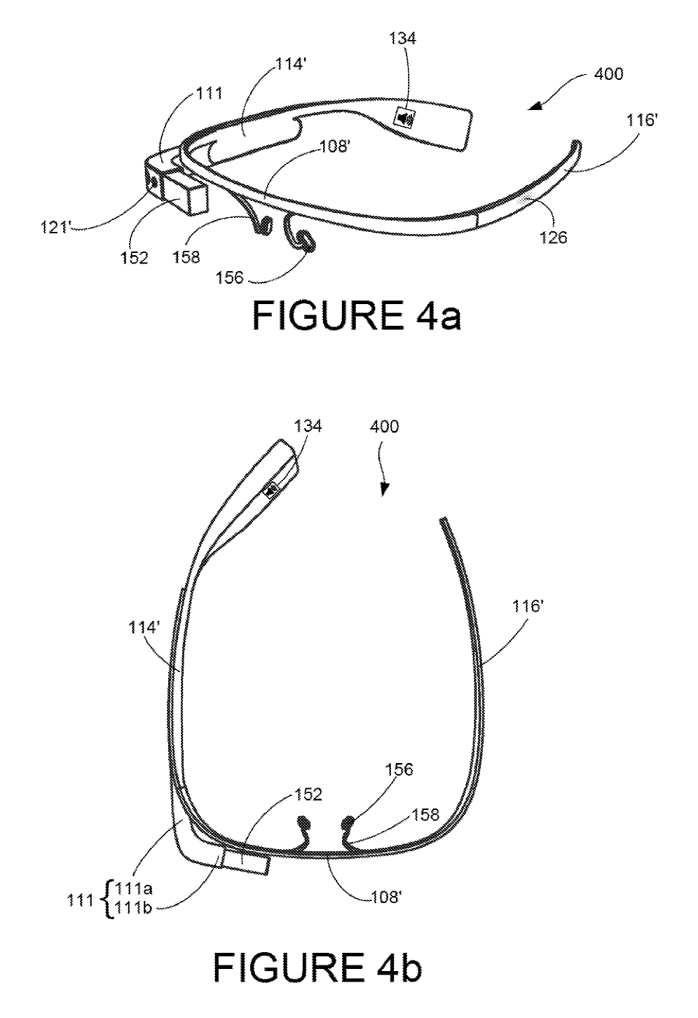

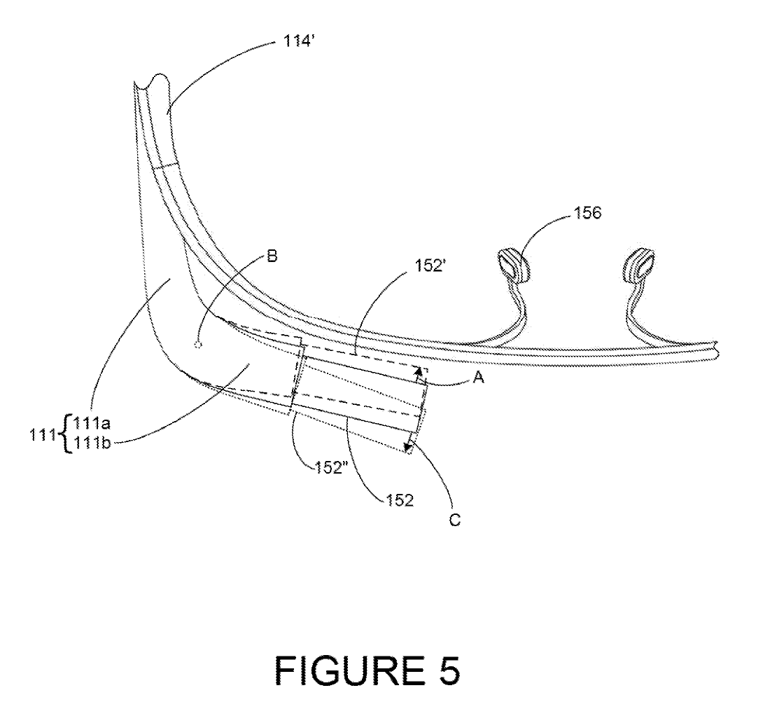

FIG. 1 illustrates an example system 100 for receiving, transmitting, and displaying data. The system 100 is shown in the form of a wearable computing device. While FIG. 1 illustrates eyeglasses 102 as an example of a wearable computing device, other types of wearable computing devices could additionally or alternatively be used, as illustrated in FIGS. 4a, 4b and 5. Referring to FIG. 1, the eyeglasses 102 comprise frame elements including lens-frames 104, 106 and a center frame support 108, lens elements 110, 112, and side arms 114, 116. The center frame support 108 and the side arms 114, 116 are configured to secure the eyeglasses 102 to a user's face via a user's nose and ears, respectively.

Each of the frame elements 104, 106, 108 and the side arms 114, 116 may be formed of a solid structure of plastic or metal, or may be formed of a hollow structure of similar material so as to allow wiring and component interconnects to be internally routed through the eyeglasses 102. Each of the lens elements 110, 112 may be formed of any material that can suitably display a projected image or graphic. Each of the lens elements 110, 112 may also be sufficiently transparent to allow a user to see through the lens element. Combining these two features of the lens elements 110, 112 can facilitate an augmented reality or heads-up display where a projected image or graphic is superimposed over a real-world view as perceived by the user through the lens elements 110, 112.

The side arms 114, 116 are each projections that extend away from the frame elements 104, 106, respectively, and portions thereof are positioned behind or otherwise adjacent to a user's ears to secure the eyeglasses 102 to the user. The side arms 114, 116 may further secure the eyeglasses 102 to the user by extending around a rear portion of the user's head. Additionally or alternatively, for example, the system 100 may connect to or be affixed within a head-mounted helmet structure. Other possibilities exist as well.

The system 100 may also include an on-board computing system 118, a video camera 120, a light pass hole 121, one or more sensors 122, and finger-operable touch pads 124, 126. The on-board computing system 118 is shown to be positioned on the side arm 114 of the eyeglasses 102; however, the on-board computing system 118 may be provided on other parts of the eyeglasses 102. The on-board computing system 118 may include a processor and memory, for example. The on-board computing system 118 may be configured to receive and analyze data from the video camera 120 and the finger-operable touch pads 124, 126 (and possibly from other sensory devices, user interfaces, or both) and generate images for output from the lens elements 110, 112.

The video camera 120 is shown to be positioned on the side arm 114 of the eyeglasses 102; however, the video camera 120 may be provided on other parts of the eyeglasses 102. The video camera 120 may be configured to capture images at various resolutions or at different frame rates. Many video cameras with a small form-factor, such as those used in cell phones or webcams, for example, may be incorporated into an example of the system 100. Although FIG. 1 illustrates one video camera 120, more video cameras may be used, and each may be configured to capture the same view, or to capture different views. For example, the video camera 120 may be forward facing to capture at least a portion of the real-world view perceived by the user. This forward facing image captured by the video camera 120 may then be used to generate an augmented reality where computer generated images appear to interact with the real-world view perceived by the user.

The light pass hole 121 may include a light emitting diode and a flash to be used in conjunction with a camera, such as video camera 120. By combining both the light emitting diode and the flash in the light pass hole 121, the functionality provided by the light pass hole 121 streamlines the design of the system 100. The light pass hole 121 is shown in the figure as being defined in the frame element 106; however, the light pass hole 121 may be defined in any other portion of the system 100.

The sensor 122 is shown mounted on the side arm 116 of the eyeglasses 102; however, the sensor 122 may be provided on other parts of the eyeglasses 102. The sensor 122 may include one or more of a gyroscope or an accelerometer, for example. Other sensing devices may be included within the sensor 122 or other sensing functions may be performed by the sensor 122.

The finger-operable touch pads 124, 126 are shown mounted on the side arms 114, 116 of the eyeglasses 102. Each of finger-operable touch pads 124, 126 may be used by a user to input commands. The finger-operable touch pads 124, 126 may sense at least one of a position and a movement of a finger via capacitive sensing, resistance sensing, or a surface acoustic wave process, among other possibilities. The finger-operable touch pads 124, 126 may be capable of sensing finger movement in a direction parallel or planar to the pad surface, in a direction normal to the pad surface, or both, and may also be capable of sensing a level of pressure applied. The finger-operable touch pads 124, 126 may be formed of one or more translucent or transparent insulating layers and one or more translucent or transparent conducting layers. Edges of the finger-operable touch pads 124, 126 may be formed to have a raised, indented, or roughened surface, so as to provide tactile feedback to a user when the user's finger reaches the edge of the finger-operable touch pads 124, 126. Each of the finger-operable touch pads 124, 126 may be operated independently, and may provide a different function.

The finger-operable touch pads 124, 126 may each be a flexible circuit that can be adhered to a surface of the corresponding side arm 114, 116 of the eyeglasses 102. The flexible circuit may be adhered using, for example, double-stick tape such that a parting line will not be provided where edges of the finger-operable touch pads 124, 126 meet the surface of the corresponding side arm 114, 116. The adhered flexible circuit may be raised slightly above the surface of the corresponding side arm 114, 116 due to a thickness of the flexible circuit or, alternatively, due to a slightly raised portion on the surface of the corresponding side arm 114, 116 to which the flexible circuit is attached. By forming the finger-operable touch pads 124, 126 without parting lines, water, dirt and dust are prevented from entering an interior of the system 100.

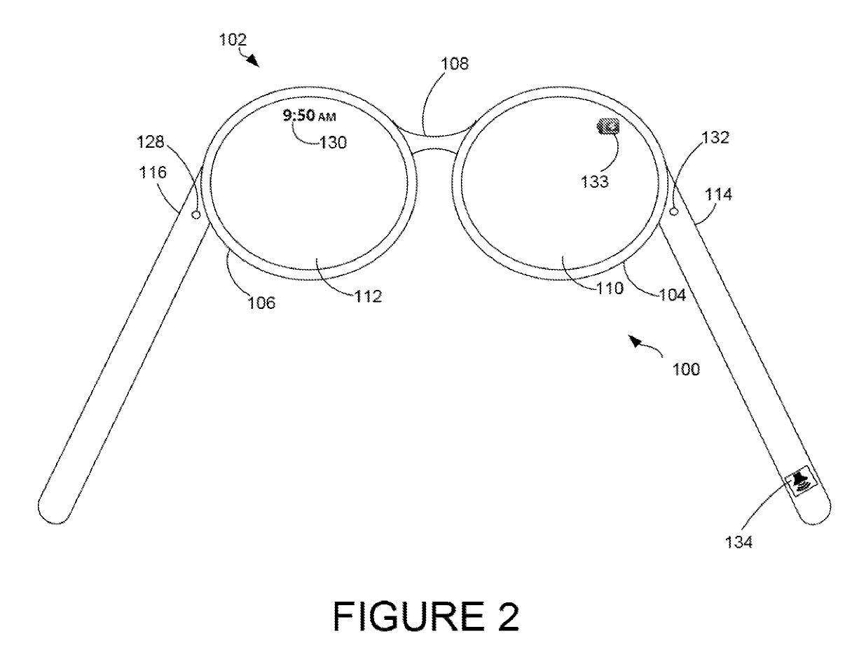

FIG. 2 illustrates an alternate view of the system 100 of FIG. 1. As shown in FIG. 2, the lens elements 110, 112 may act as display elements. The eyeglasses 102 may include a first projector 128 coupled to an inside surface of the side arm 116 and configured to project an image 130 onto an inside surface of the lens element 112. Additionally or alternatively, a second projector 132 may be coupled to an inside surface of the side arm 114 and configured to project an image 133 onto an inside surface of the lens element 110.

The lens elements 110, 112 may act as a combiner in a light projection system and may include a coating that reflects the light projected onto them from the projectors 128, 132. In some embodiments, a special coating may not be used (e.g., when the projectors 128, 132 are scanning laser devices).

In alternative embodiments, other types of display elements may also be used. For example, the lens elements 110, 112 themselves may include: a transparent or semi-transparent matrix display, such as an electroluminescent display or a liquid crystal display, one or more waveguides for delivering an image to the user's eyes, or other optical elements capable of delivering an in-focus near-to-eye image to the user. A corresponding display driver may be disposed within the frame elements 104, 106 for driving such a matrix display. Alternatively or additionally, a laser or LED source (such as the light emitting diode provided in light pass hole 121) and scanning system could be used to draw a raster display directly onto the retina of one or both of the user's eyes. Other possibilities exist as well.

The eyeglasses 102 may include a transmitter-transducer such as a bone conduction transducer 134 coupled to an inside surface of the side arm 114. The transducer 134 is configured to transmit a signal to cause vibrations in a bone (such as the user's temporal bone). In this regard, the transducer 134 behaves like a speaker without a diaphragm. The transducer 134 does not generate sound waves travelling through the air to transmit audio to the user's ear. Rather, the transducer 134 vibrates the user's inner ear indirectly via vibrations in the user's skull or other bones in the user's head proximate to where the transducer 134 is positioned. In other words, the vibrations generated by the transducer 134 cause the user to perceive sound via the cochlea in the user's inner ear while bypassing the eardrum in the user's middle ear. Accordingly, the user can perceive the sound generated by the transducer 134 but the sound is not projected outward to others in the vicinity. This bone conduction sound transmission method provides a personal and discreet listening experience for the user such that others nearby cannot hear the audio transmitted by the transducer 134.

The position where the transducer 134 is provided proximate to the user's skull affects the quality of audio perceived by the user. In order to produce the best sound quality, the transducer 134 should be positioned near the ear canal at the user's tragus (e.g., temple). However, it is difficult to provide the transducer 134 on one of the side arms 114, 116 such that the transducer 134 contacts the user's tragus while maintaining a streamlined system design.

In order to produce acceptable sound quality and also provide a stylish design aesthetic, the transducer 134 may be provided on one of the side arms 114, 116 proximate a free end thereof such that the transducer 134 contacts the user's mastoid (i.e., near the back of the user's head behind the ear). When the eyeglasses 102 are designed such that the transducer 134 contacts the user's mastoid, the perceived volume and sound quality suffers slightly, but the wearable computing device is more visually appealing than when the transducer 134 contacts the user's tragus. There is also a comfort advantage to having the transducer 134 contacting the user's mastoid because nothing on the eyeglasses 102 presses against the user's temple.

In order to achieve good sound quality, the contact plate of the transducer 134 should firmly abut against the user's head. Accordingly, the side arms 114, 116 should be appropriately adjusted and the transducer 134 should be provided on one of the side arms 114, 116 at a location that results in the side arms 114, 116 naturally pushing the transducer 134 against the user's head without any unnecessary pressure.

The rigidity of the contact plate may also affect audio transmission. Specifically, a soft plate muffles higher frequencies and transmits mostly at the lower frequencies such that the range of audio frequencies is clipped. For example, in the case of a contact plate made of rubber, the frequency attenuation between the bone conduction transducer 134 and the user's skin is in the range of 600 Hz-900 Hz. The range may be shifted depending on a thickness and durometer of the rubber.

A hard, dense plate provides better sound transmission because it transmits the majority of the sound without changing frequency. Accordingly, a harder contact plate is generally preferred over a softer contact plate. For example, a metal contact plate provides better sound quality over a plastic contact plate. Since different metals do not exhibit the same frequency response, the type of metal used for the contact plate may also affect transducer performance. Specifically, heavier metals require more transducer effort to transmit audio. For example, a transducer made of aluminum has a better performance than a transducer made of a heavier metal such as brass.

The size of the contact plate may determine a frequency range at which the transducer 134 transmits signals. A larger contact plate may suffer from sound leakage. In contrast, a smaller contact plate may provide a more personalized audio experience. In some embodiments, a smaller contact plate is desirable to reduce sound leakage and to provide a more personal audio experience for the user.

In other embodiments, a larger contact plate may be desirable to cause the contact plate to behave as a diaphragm that moves air, resulting in a hybrid audio input provided to the ear via both the eardrum and the cochlea. In other words, the larger contact plate may enable one portion of the audio input to be provided to the user through bone conduction and another portion of the audio input to be provided to the user as traditional sound via air pressure distortion. A larger plate may also be desirable to provide better contact with the user's head. Since there is widespread differentiation in the size and shape of human heads, it becomes difficult for smaller plates to effectively contact different head shapes.

User comfort at the location where the contact plates touch the user's head is important since the transducer 134 continuously presses against the user to transmit audio. Ideally, the contact plates should be soft enough to conform to the shape of the user's head, and sufficiently rigid to transmit audio without adversely affecting frequency response. In order to address these concerns, the contact plate may include a non-Newtonian fluid (e.g., oobleck). A non-Newtonian fluid has flow properties that differ from Newtonian fluids. For example, the viscosity of non-Newtonian fluids in not independent of shear rate or shear rate history. A non-Newtonian fluid may stiffen when pressed sharply, but when pressed slowly, the non-Newtonian fluid may be easily moved though. The contact plate of the transducer 134 may therefore include a pouch of non-Newtonian fluid that stiffens during high frequency signal transmission, and that becomes more supple and compliant at lower frequencies to conform to the surface of the user's head. Generally, a non-Newtonian fluid is stiff at a frequency range of approximately 60 Hz-4000 Hz to transmit most of the human audible range, and a non-Newtonian fluid is soft/compliant at lower frequencies.

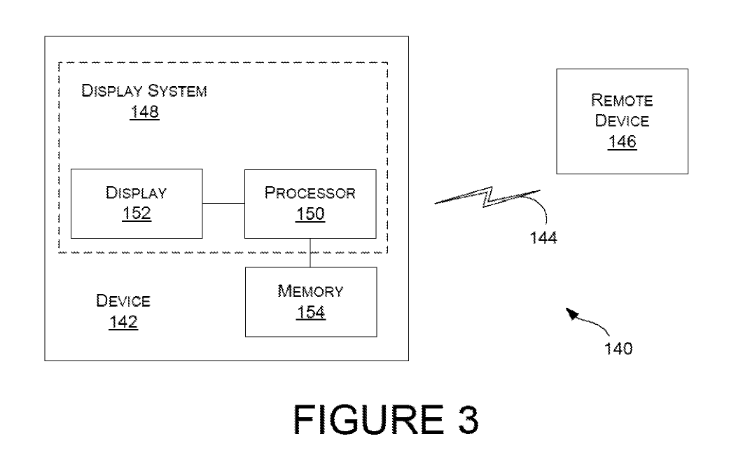

FIG. 3 illustrates an example schematic drawing of a computer network infrastructure for use with aspects of the disclosure. In one system 140, a device 142 communicates using a communication link 144 (e.g., a wired or wireless connection) to a remote device 146. The device 142 may be any type of device that can receive data and display information corresponding to or associated with the data. For example, the device 142 may be a heads-up display system, such as the system described with reference to FIGS. 1 and 2 or the system 400 described with reference to FIGS. 4a, 4b and 5.

The device 142 may include a display system 146 comprising a processor 150 and a display 152. The processor 150 may be included in the on-board computing system 118 (FIG. 1). The display 152 may be, for example, an optical see-through display, an optical see-around display, or a video see-through display. The processor 150 may receive data from the remote device 146, and configure the data for display on the display 152. The processor 150 may be any type of processor, such as a micro-processor or a digital signal processor, for example.

The device 142 may further include on-board data storage, such as memory 154 coupled to the processor 150. The memory 154 may store software that can be accessed and executed by the processor 150, for example.

The remote device 146 may be any type of computing device or transmitter including a laptop computer, netbook, tablet PC, mobile telephone, etc., that is configured to transmit data to the device 142. The remote device 146 and the device 142 may contain hardware to enable the communication link 144, such as processors, transmitters, receivers, antennas, etc.

In FIG. 3, the communication link 144 is illustrated as a wireless connection; however, wired connections may also be used. For example, the communication link 144 may be a wired link via a serial bus such as a universal serial bus, or a parallel bus. A wired connection may be a proprietary connection as well. The communication link 144 may also be a wireless connection using, e.g., Bluetooth® radio technology, communication protocols described in IEEE 802.11 (including any IEEE 802.11 revisions), cellular technology (such as GSM, CDMA, UMTS, EV-DO, WiMAX, or LTE), or Zigbee® technology, among other possibilities. The remote device 146 may be accessible via the Internet and may comprise a computing cluster associated with a particular web service (e.g., social-networking, photo sharing, address book, etc.).

FIGS. 4a and 4b illustrate an example system 400 for receiving, transmitting, and displaying data. The system 400 is a wearable computing device and includes many of the same components included in the system 100 described above. The system 400 includes a center frame support 108′. Side arms 114′, 116′ extend from opposite ends of the center frame support 108′. The bone conduction transducer 134 is attached to an inner portion of the side arm 114′ proximate a free end thereof. A pair of nose pads 156 extends downward from the center frame support 108′ via nose pad arms 158.

A generally L-shaped extension arm 111 extends from the side arm 114′. The extension arm 111 includes an extension portion 111a and an attachment portion 111b. The extension portion 111a extends substantially orthogonal from the side arm 114′ in a direction that is substantially collinear with the side arm 114. The attachment portion 111b extends at an angle from the extension portion 111a such that the attachment portion 111b extends toward the center frame support 108′ and is substantially parallel thereto. The display 152 is attached to a free end of the attachment portion 111b such that the display 152 may be provided in the user's line of vision when the wearable computing device is worn. A light pass hole 121′ may be provided on the attachment portion 111b such that light from an LED or a flash is outwardly provided relative to a front of the user's head. Although not shown in the figure, the light pass hole 121′ may be alternatively provided on the center frame support 108′.

FIG. 5 illustrates a partial, operational view of a wearable computing device in accordance with an example embodiment. In some embodiments, the extension arm 111 may include both rigid and pliable material. Specifically, the part of the extension portion 111a that extends from the side arm 114′ is made of rigid material, the part of the attachment portion 111b to which the display 152 is attached is made of rigid material, and the part of the extension arm 111 at a junction between the extension portion 111a and the attachment portion 111b is made of pliable material.

The position of the display 152 relative to the user's eye often requires adjustment such that the user may be able to view the display 152 clearly. There is a limited range of distance and tilt where the user can view the entire display 152. The combination of the rigid and pliable material in the extension arm 111 allows a user to manipulate the extension arm 111 and control a distance between the display 152 and the user's eye. Specifically, the user may reduce the distance between the display 152 and the user's eye by moving the display 152 the attachment portion 111b in the direction of arrow “A” such that the display rotates at pivot “B” until the display reaches position 152′. Similarly, the user may increase the distance between the display 152 and the user's eye by moving the display 152 and the attachment portion 111b in the direction of arrow “C” such that the display rotates at pivot “B” until the display reaches position 152″. Generally, the optical plane of the display 152 should be substantially normal to a center of the user's eye. Further adjustments may be made my moving a location where the nose pads 156 contact the user's nose. In some embodiments, the extension arm 111 may include a hinge mechanism (not shown) such that the display and the attachment portion 111b are rotatable around pivot “B”.

As described above, a wearable computing device includes a bone conduction transducer, an extension arm projecting from a side arm of the device, a light pass hole, and a flexible touch pad input circuit. When a user wears the device, the transducer contacts the user's head at a position proximate the user's skull. A display is attached to a free end of the extension arm. The extension arm is partially made of pliable material or may include a hinge mechanism such that a user may adjust a distance of the display relative to the user's eye for the user to view the display at an optimum position. The light pass hole may include both a light emitting diode and a flash that may be used in conjunction with a camera. The flexible touch pad input circuit may be adhered to at least one side arm of the device such that there are no parting lines between edges of the flexible touch pad input circuit and a surface of the corresponding side arm. As these and other variations and combinations of the features discussed above can be utilized without departing from the scope of the claims, the foregoing description of exemplary embodiments should be taken by way of illustration rather than by way of limitation. It will also be understood that the provision of examples (as well as clauses phrased as “such as,” “e.g.”, “including” and the like) should not be interpreted as limiting; rather, the examples are intended to illustrate only some of many possible aspects.

1. A computing device configured to be wearable on a user's head, the computing device comprising:
a center frame support;
a first side arm extending from a first end of the center frame support;
a second side arm extending from a second end of the center frame support; and
a bone conduction transducer provided on one of the first and second side arms and configured to contact the user's head at a first location thereof, wherein the first location is proximate the skull of the user's head.

2. The device of claim 1, wherein the bone conduction transducer is configured to transmit a signal causing the skull to vibrate at one or more frequencies.

3. The device of claim 1, wherein the bone conduction transducer is provided on a free end of the one of the side arms, the free end being opposite the first or second end of the center frame support.

4. The device of claim 1, wherein the bone conduction transducer comprises a contact plate configured to contact the user's head at the first location.

5. The device of claim 4, wherein the contact plate comprises metal.

6. The device of claim 4, wherein the contact plate comprises a non-Newtonian fluid.

7. The device of claim 4, wherein a size of the contact plate causes the contact plate to behave as a diaphragm configured to move air.

8. The computing device of claim 1, further comprising an extension arm projecting from one of the side arms in a direction proximate the center frame support.

9. The computing device of claim 8, further comprising a display attached to a free end of the extension arm, wherein the display is configured to be provided proximate the user's line of vision for at least one eye.

10. The computing device of claim 9, wherein the extension arm is substantially L-shaped, and comprises an extension portion extending from the one of the side arms and an attachment portion extending generally orthogonal to the extension portion in a direction that is substantially parallel to the center frame support, the display being attached to a free end of the attachment portion.

11. The computing device of claim 10, wherein the extension arm comprises rigid material and pliable material such that a distance of the display relative to the user is adjustable, the extension portion comprising the rigid material proximate the one of the side arms and the pliable material proximate the attachment portion, the attachment portion comprising the rigid material proximate the free end thereof and the pliable material proximate the extension portion.

12. The computing device of claim 10, wherein the extension arm comprises a hinge mechanism between the extension portion and the attachment portion such that a distance of the display relative to the user is adjustable.

13. The computing device of claim 8, wherein a light pass hole is defined in the extension arm.

14. The computing device of claim 13, further comprising a light emitting diode and flash provided in the light pass hole.

15. The computing device of claim 1, wherein a light pass hole is defined in the center frame support.

16. The computing device of claim 15, further comprising a light emitting diode and flash provided in the light pass hole.

17. The computing device of claim 1, further comprising a flexible touch pad input circuit attached to at least one of the side arms.

18. The computing device of claim 17, wherein the flexible touch pad input circuit is attached to the at least one of the side arms using an adhesive.

19. The computing device of claim 17, wherein a parting line is not formed between edges of the flexible touch pad input circuit and a surface of the at least one of the side arms.

20. The computing device of claim 17, wherein the flexible touch pad input circuit is raised above a surface of the at least one of the side arms.

21. A computing device configured to be wearable on a user's head, the computing device comprising:
a center frame support;
a first side arm extending from a first end of the center frame support;
a second side arm extending from a second end of the center frame support;
an extension arm projecting from one of the side arms in a direction proximate the center frame support; and
a display attached to a free end of the extension arm, wherein the display is configured to be provided proximate the user's line of vision for at least one eye.

22. The computing device of claim 21, wherein the extension arm is substantially L-shaped, and comprises an extension portion extending from the one of the side arms and an attachment portion extending generally orthogonal to the extension portion in a direction that is substantially parallel to the center frame support, the display being attached to a free end of the attachment portion.

23. The computing device of claim 22, wherein the extension arm comprises rigid material and pliable material such that a distance of the display relative to the user is adjustable, the extension portion comprising the rigid material proximate the one of the side arms and the pliable material proximate the attachment portion, the attachment portion comprising the rigid material proximate the free end thereof and the pliable material proximate the extension portion.

24. The computing device of claim 22, wherein the extension arm comprises a hinge mechanism between the extension portion and the attachment portion such that a distance of the display relative to the user is adjustable.

25. The device of claim 21, further comprising:
a bone conduction transducer provided on one of the side arms and configured to contact the user's head at a first location thereof, wherein the first location is proximate the skull of the user's head.

26. The device of claim 25, wherein the bone conduction transducer is configured to transmit a signal causing the skull to vibrate at one or more frequencies.

27. The device of claim 25, wherein the bone conduction transducer is provided on a free end of the one of the side arms, the free end being opposite the first or second end of the center frame support.

28. The device of claim 25, wherein the bone conduction transducer comprises a contact plate configured to contact the user's head at the first location.

29. The device of claim 28, wherein the contact plate comprises metal.

30. The device of claim 28, wherein the contact plate comprises a non-Newtonian fluid.

31. The device of claim 28, wherein a size of the contact plate causes the contact plate to behave as a diaphragm configured to move air.
